(19) United States
(12) Patent Application Publication
(10) Pub. No.: US 2026/0046790 A1
(43) Pub. Date: Feb. 12, 2026

(54) EXTENDED HOLDOVER TIMING IN CELLULAR NETWORKS

(71) Applicant: DISH Wireless L.L.C., Englewood, CO (US)

(72) Inventors: John Sabando, Englewood, CO (US); Arnold Agcaoili, Littleton, CO (US); Borong Zheng, Littleton, CO (US)

(21) Appl. No.: 18/796,128

(22) Filed: Aug. 6, 2024

(51) Int. Cl. H04W 56/00; H04J 3/06

(52) U.S. Cl. CPC H04W 56/001; H04J 3/0667; H04J 3/0688

(57) ABSTRACT

A system and method for maintaining timing synchronization in cellular networks during GPS signal loss is provided. A cloud services router (CSR) receives a primary timing reference from a GPS receiver. Upon detecting loss of the GPS signal, the CSR enters a holdover mode for a predetermined duration, utilizing a first clock class indicating a traceable backup timing source. The CSR generates a backup timing signal using its internal oscillator and provides this to downstream devices. If the GPS signal is restored within the holdover period, normal operation resumes. If the holdover period expires without GPS restoration, the CSR advertises a second clock class indicating a free-run state. The disclosed technique bridges temporary GPS outages without impacting service quality, reducing dropped calls and service interruptions. The holdover duration is configurable, with 30 minutes used in one embodiment as sufficient to outlast typical GPS signal flapping events.

### TECHNICAL FIELD

The present disclosure relates to wireless telecommunication networks, and specifically to systems and methods for Distributed Unit (DU) pooling in Open Radio Access Network (ORAN) wireless telecommunication networks.

### BRIEF SUMMARY

In various example embodiments, systems and methods are disclosed for implementing extended holdover timing in cellular networks. Modern cellular networks rely on precise timing and synchronization between network elements to function properly. Traditionally, cell sites have used GPS receivers to provide a primary timing reference. These GPS-derived timing signals are then distributed to various network components at the cell site, including cloud services routers (CSRs) that receive the primary reference timing signals.

Each cell site typically operates as its own standalone Precision Time Protocol (PTP) timing domain. The CSR at the site acts as a PTP grandmaster, receiving the GPS timing and translating it into PTP and Synchronous Ethernet (SyncE) signals for consumption by downstream network elements like distributed units (DUs) and radio units (RUs).

However, this GPS-based technique may present some problems in certain scenarios. GPS signals can be disrupted by various factors including weather, physical obstructions, or equipment failures. When GPS reception is lost, even temporarily, it can cause the entire timing chain at a cell site to become unstable. This instability can lead to service disruptions if not mitigated quickly.

In 5G networks, and particularly in Open RAN (ORAN) architectures, timing requirements are even more stringent than in previous cellular generations. Extremely precise synchronization between network elements is needed to enable advanced features like beamforming and to maintain spectral efficiency. Even brief losses of accurate timing can potentially impact network performance and user experience. Thus, an important issue facing cellular service providers deploying 5G ORAN networks is how to maintain precise timing and synchronization during temporary GPS outages or signal degradations. Statistical analysis of operational networks has shown that GPS signal “flapping” (where the signal rapidly alternates between available and unavailable states) is a common occurrence. These flapping events can last anywhere from a few seconds to several minutes.

When GPS flapping occurs, it disrupts the primary timing reference for the cell site. This in turn can lead to timing instability in the CSR acting as the PTP grandmaster. As the CSR's timing degrades, it may change its advertised PTP clock class, potentially triggering downstream devices like DUs and RUs to enter free-run modes or shut down entirely. The result can be dropped calls, service interruptions, and poor user experiences. Therefore, a challenge is how to bridge these temporary GPS outages without impacting service quality.

The systems and methods disclosed herein facilitate providing a stable backup timing source that can maintain synchronization across the cell site for a sufficient period to outlast typical GPS flapping events. This allows normal operations to continue uninterrupted during brief primary reference losses.

In an example embodiment, the systems and methods described herein address the GPS flapping issue by implementing an enhanced holdover capability in the CSR. This allows the CSR to maintain a stable and accurate timing reference for a defined period even when the primary GPS signal is lost.

In an example embodiment, the CSR is configured with an extended holdover duration, (e.g., 30 minutes). Although not obvious, it was discovered by the inventors of the techniques disclosed in the present Application that this duration may cover the vast majority of observed GPS flapping events in operational networks. However, the duration is configurable and may vary in different embodiments. Logic is implemented in the CSR to advertise a specific PTP clock class (Class 7) during the holdover period. This indicates to downstream devices that while the primary reference is unavailable, a traceable backup source is being used.

In an example embodiment, the CSR's internal oscillator, disciplined by historical GPS timing data, is utilized to generate a highly stable backup frequency reference during holdover periods. Phase and time alignment techniques are applied to ensure the holdover timing closely tracks the expected behavior of the missing GPS signal. The systems and methods described herein facilitate gracefully transitioning to and from holdover mode to minimize disruptions in the timing chain.

In an example embodiment, when a GPS signal loss is detected, the CSR immediately enters holdover mode. The CSR continues to output PTP and SyncE signals derived from its internal oscillator, maintaining phase alignment with the last known good GPS timing. The CSR advertises itself as a PTP Class 7 clock, indicating to downstream devices that while not locked to GPS, it is still providing a traceable and reliable timing source.

This Class 7 advertisement prevents DUs and RUs from entering their own free-run states or shutting down. Instead, these devices continue to accept timing from the CSR, allowing normal network operations to proceed.

If GPS reception is restored within the example 30-minute holdover window, the CSR smoothly transitions back to using the GPS reference. In most cases, this transition can occur without downstream devices even detecting a change.

If the GPS outage extends beyond the example 30 minutes, the CSR will exhaust its holdover capability. At this point, the CSR changes its advertised clock class to 160 (free-run) and downstream devices take appropriate actions such as ceasing radio transmissions to avoid interference.

By implementing this enhanced holdover technique, cellular service providers can significantly reduce the impact of GPS flapping and other short-term timing disruptions. The 30-minute holdover window provides ample time for many GPS issues to self-resolve or for operations teams to begin troubleshooting more persistent problems. Thus, the systems and methods described herein may reduce occurrences of call drops and service interruptions related to GPS flapping, providing a robust and standards-compliant method for improving timing resiliency in 5G ORAN networks without requiring significant architectural changes or new hardware deployments.

### BRIEF DESCRIPTION OF THE DRAWINGS

FIG. 1A is a block diagram of a system 100 for implementing a possible synchronization technique in 5G Networks that presents certain problems related to GPS signal flapping, according to one non-limiting embodiment.

FIG. 1B is a diagram illustrating Precision Time Protocol (PTP) synchronization concepts 104 that may be implemented in the system 100 of FIG. 1A, according to one non-limiting embodiment.

FIG. 2 is a block diagram of a system depicting the behavior of a 5G ORAN system implementing the possible synchronization technique in 5G Networks illustrated in FIG. 1A in which certain problems related to GPS signal flapping may occur, according to one non-limiting embodiment.

FIG. 3 is a block diagram of a system implementing an extended holdover technique that addresses the problems present in the techniques shown in FIG. 1A and FIG. 2, according to one non-limiting embodiment.

FIG. 4 is a flow diagram of an example method for extended holdover timing in cellular networks that may be implemented within the system of FIG. 3, according to one non-limiting embodiment.

FIG. 5 is a flow diagram of an example method for operating in holdover mode useful in the method of FIG. 4, according to one non-limiting embodiment.

FIG. 6 is a flow diagram of an example method for providing the backup timing signal to downstream network devices useful in the method of FIG. 5, according to one non-limiting embodiment.

FIG. 7 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

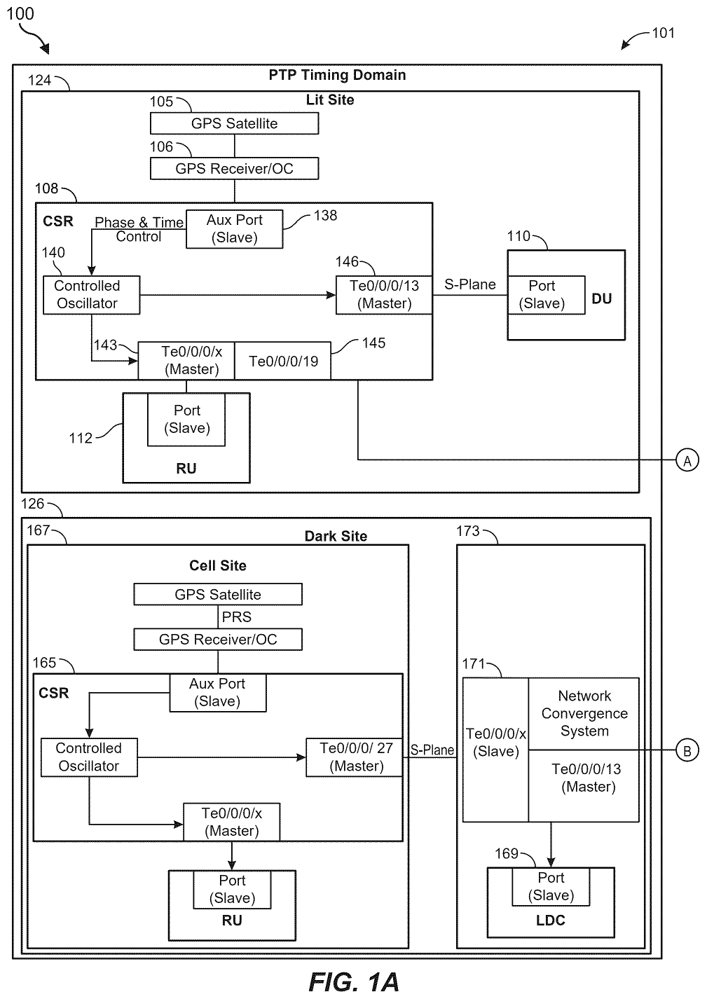

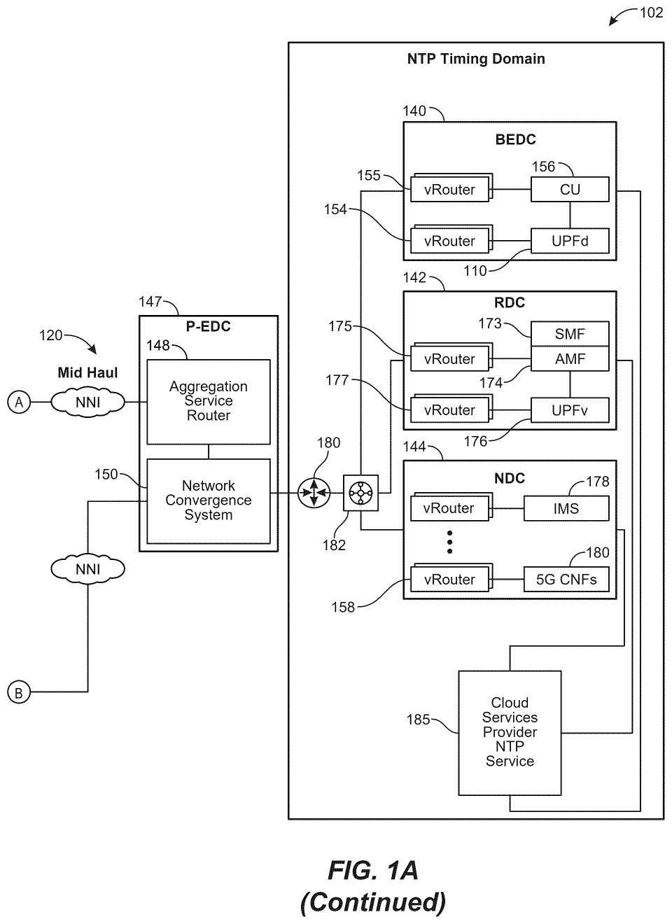

FIG. 1A is a block diagram of a system 100 for implementing a possible synchronization technique in 5G Networks that presents certain problems related to GPS signal flapping, according to one non-limiting embodiment.

The system 100 is divided into two main sections: the PTP Timing Domain 101 and the Network Time Protocol (NTP) Timing Domain 102. In the PTP Timing Domain 101, there are two types of sites shown: a Lit Site 124 and a Dark Site 126. Each cell site is equipped with a GPS satellite receiver 106 to provide primary timing reference from a GPS satellite 105. The Lit Site 124 includes a cloud services router (CSR) 108 that receives the primary reference timing signal from the GPS receiver 106 and functions as a PTP and Telecom Grandmaster (T-GM). In some example embodiments, the CSR 108 may be a Cisco® Network Convergence System (NCS) 540 Series router.

The CSR 108 contains several components for timing and synchronization. An Aux Port 138 enables timing input. The Controlled Oscillator 140 provides precise frequency control, maintaining accurate timing even during short GPS outages. The Te0/0/0/x (Master) port 143 and Te0/0/0/13 (Master) port 146 are responsible for distributing timing information to other network elements, while the Te0/0/0/19 port 145 handles general network connectivity. These components work together via a SyncE Hardware Clock for synchronous Ethernet timing functions, a PTP Software Stack for managing PTP operations and a SyncE Software Stack for handling software aspects of Synchronous Ethernet timing to maintain accurate timing across the network.

The CSR 108 is connected to a distributed unit (DU) 110 via the Te0/0/0/13 (Master) port 146 on the Synchronization Plane (S-Plane), which is responsible for distributing and maintaining accurate timing and synchronization information across the network. The CSR 108 is also connected to a radio unit (RU) 112 via the Te0/0/0/x (Master) port 143. The Dark Site 126 includes similar components but is shown in a non-operational state and illustrates the CSR 165 of the cell site 167 communicating with the DU 169 via a network convergence system (NCS) 171 at a local data center (LDC). In an example embodiment, each cell site operates as a standalone PTP timing domain (e.g., PTP Domain 24) by itself.

The NTP Timing Domain 102 shows various network elements connected to the PTP Timing Domain 101 through a mid-haul network 120 including Network-to-Network Interface (NNI) routers. In an example embodiment, within the NTP Timing Domain 102, included is a Breakout Edge Data Center (BEDC) 141, which hosts edge computing resources and may include a 5G User Plane Function (UPF) denoted as UPFd 110. The BEDC 141 incorporates virtual routers (vRouters) 154 connected to the UPFd 110 and vRouters 155 connected to a CU 156 that facilitate flexible routing and network function virtualization at the edge.

A Regional Data Center (RDC) 142 within the NTP Timing Domain 102 hosts regional network functions like the Access and Mobility Management Function (AMF) and Session Management Function (SMF). The RDC 142 also includes vRouters 175 connected to the AMF 174 and to manage inter-function communication and regional traffic routing. The RDC 142 may also include vRouters 175 connected to a 5G UPF denoted as UPFv 176, which is in turn connected to the AMF 174 to manage inter-function communication and regional traffic routing.

A National Data Center (NDC) 144 hosts national-level services and operations support systems. The NDC 144 employs vRouters 158 connected to an IP Multimedia Subsystem (IMS) 178 and 5G Cloud-Native Functions (CNFs) for high-level network orchestration and to facilitate communication between national-level services. A cloud services provider NTP service 185 connected to the BEDC 141, RDC 142, and NDC 144 provides network time synchronization.

In an example embodiment, the vRouters in the BEDC 141, RDC 142, and NDC 144 collectively form an overlay network that allows for flexible routing and management of network functions across different cloud environments. This overlay network enables the distributed network stack to appear as a single, unified network.

A Pass-through Edge Data Center (P-EDC) 147 connected to the NTP Timing Domain 102 via a network router 180 and network switch 182 aggregates traffic from multiple cell sites. The P-EDC 147 may include an aggregation service router (ASR) 148 connected to a network convergence system (NCS) 150 that is connected to network router 180 of the NTP Timing Domain for interconnecting different network domains. In an example embodiment, the ASR 148 may be a Cisco® ASR 9904 Router and the NCS 150 may be a Cisco NCS 5504 router.

FIG. 1B is a diagram illustrating Precision Time Protocol (PTP) synchronization concepts 104 that may be implemented in the system 100 of FIG. 1A, according to one non-limiting embodiment. FIG. 1B provides a view of PTP synchronization concepts 104, encompassing frequency, phase, and time synchronization, while also illustrating the protocol's integration with network layers and complementary synchronization technologies. Three main parameters of PTP synchronization are displayed, which include Frequency, Phase, and Time and form the foundation of the synchronization process.

Frequency Synchronization 190 ensures that the frequency of the local clock in the cell site matches that of the PTP Grandmaster Clock, also known as the Primary Reference Clock (PRC). This is illustrated with two clocks, Clock A and Clock B, showing identical time intervals between pulses, although the pulses themselves may not occur simultaneously.

The Phase Synchronization 191 of PTP ensures that timing pulses occur at precisely the same moment across different clocks. This is illustrated with Clock A and Clock B displaying aligned pulses, emphasizing that both the time interval and the pulse occurrences are synchronized.

Time Synchronization 192 goes beyond mere pulse alignment, incorporating the ability to transmit the exact time information within the synchronization signal. This is illustrated by showing Clock A and Clock B with identical timestamps (8:24:45, 8:24:46, 8:24:47, 8:24:48) for each pulse, indicating perfect alignment of pulses and equality of timestamps on each synchronization signal.

Relevant standards and protocols involved in PTP synchronization include PTP 1588, Profile 8275.1 194, relevant to the Phase Synchronization 191 and Time Synchronization 192, and Synchronous Ethernet (SyncE) G.781 193 relevant to Frequency Synchronization 190. There exists a complementary relationship between these protocols for comprehensive network synchronization.

Shown is the protocol stack involved in the synchronization process, including the network layers on which SyncE 196 and PTP 197 operate. Illustrated are SyncE 196, defined by SyncE G.781, and PTP 197, defined by PTP 1588, Profile 8275.1 194 functioning over Ethernet layer 198 and physical layer 199.

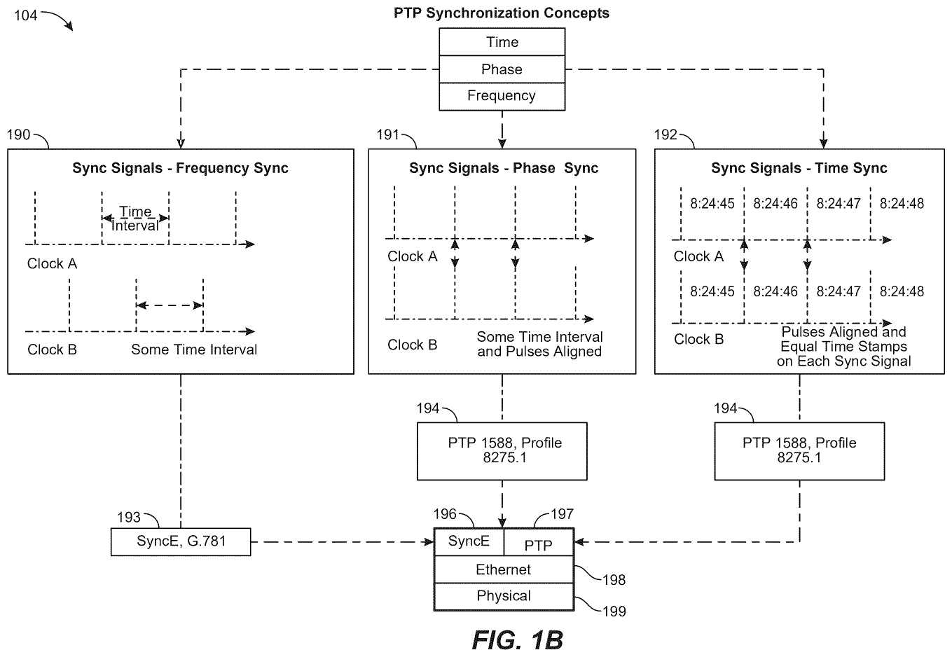

FIG. 2 is a block diagram of a 5G ORAN system 200 depicting the possible synchronization technique in 5G Networks illustrated in FIG. 1A in which certain problems related to GPS signal flapping may occur. In particular, FIG. 2 depicts the behavior of a 5G ORAN system 200 without the extended holdover technique, illustrating the problems that can arise during GPS signal loss. Shown are two states: normal operation state 201 and GPS signal loss state 202. In an example embodiment, the cell site operates as a standalone PTP timing domain (e.g., PTP Domain 24) by itself separate from the NTP Domain 256 in communication with the DU 208.

As shown in normal operation state 201, the system 200 includes a GPS satellite 203, a GPS receiver 204, a CSR 206, a DU 208, and an RU 210. In the present example, the system utilizes the Low Layer Split Configuration 3 (LLS-C3) within the Open RAN (ORAN) architecture, which is designed to ensure accurate timing distribution across the network, particularly between DUs and RUs. The CSR 206 contains timing components similar to those in FIG. 1A. The coaxial port (Slave) 224 stands ready to accept timing input from the GPS receiver 204. The oscillator 226 is locked and maintains precise frequency control based on the GPS signal from the coaxial port (Slave) 224. The Te0/0/0/x (Master) port 228 and Te0/0/0/13 (Master) port 232 distribute timing information to the RU 210 and DU 208, respectively. In this state, the CSR 206 is shown with a PTP clock class of 6, indicating it is locked to the GPS signal. Both the DU 208 and RU 210 are in a “Locked” state, with normal uplink (UL)/downlink (DL) data flow between them as indicated by the UL/DL data line 240 and the resulting data line 242 to the user equipment (UE) 244.

In the GPS signal loss state 202, after GPS signal loss 229, the CSR 206 immediately switches its clock class from 6 to 160, indicating it is in a free-run state. The oscillator 226 attempts to maintain timing, but without the GPS reference, its accuracy quickly degrades. The Te0/0/0/x (Master) port 228 and Te0/0/0/13 (Master) port 232 continue to distribute timing, but the quality is significantly reduced. The DU 208 receives notification (e.g., an ID 18 message 250) from the RU 210 of this state change, indicating a change from clock class 6 to 160, and resets the RU 210, as indicated by the deactivate/restore command 252 sent to the RU 210. This causes the RU 210 to stop radiating, as indicated by the “Free Run” state of the oscillator 226, absence of the UL/DL data line 240 and the resulting absence of data line 242 to the UE 244. However, this immediate transition to a free-run state during GPS signal loss can lead to dropped calls, service interruptions, and poor user experiences.

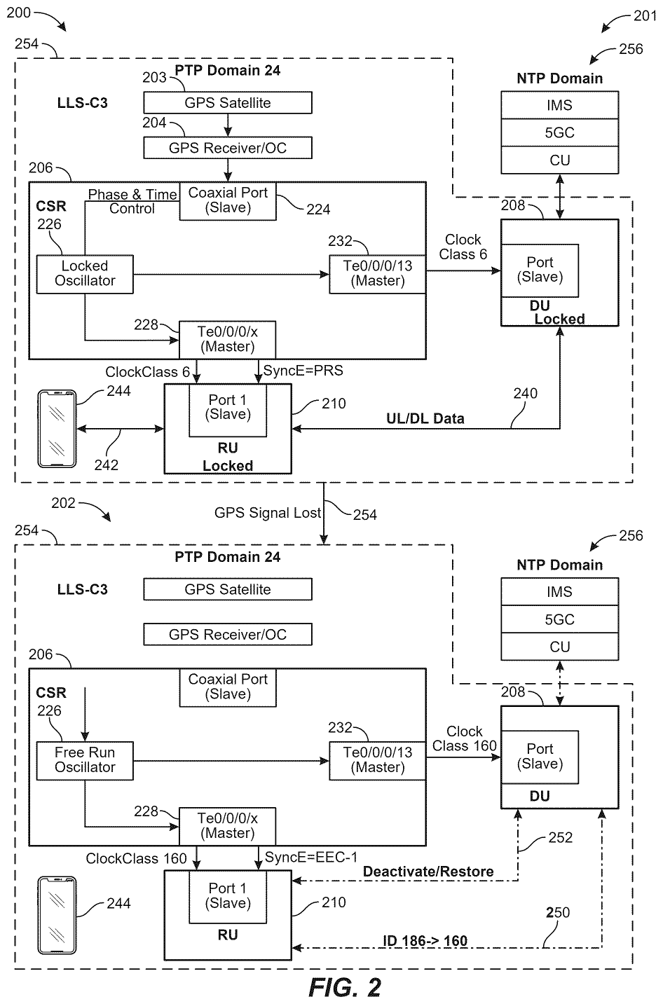

FIG. 3 is a block diagram of a system 300 implementing an extended holdover technique that addresses the potential problems present in the techniques shown in FIG. 1A and FIG. 2, according to one non-limiting embodiment.

The technique shown being implemented by the system 300 maintains timing synchronization in a cellular network during temporary GPS outages, solving an issue faced by cellular service providers deploying 5G ORAN networks. Shown are three operational states of the system 300: normal working condition state 301, GPS signal loss with holdover active state 302, and holdover expiration state 303.

In the normal working condition state 301, the system 300 operates similarly to the one in FIG. 2, with a GPS satellite 306 providing timing signals through a GPS receiver/grandmaster clock 308 to a CSR 312, which then synchronizes a DU 314 and an RU 316. In the present example, the system also utilizes the LLS-C3 within the ORAN architecture. The CSR 312 contains the similar timing components as in FIG. 2. The coaxial port (Slave) 328 stands ready to accept timing input from the GPS receiver 204. The oscillator 330 maintains precise frequency control based on the GPS signal. The Te0/0/0/x (Master) port 332 and Te0/0/0/13 (Master) port 336 distribute accurate timing to the RU 316 and DU 314, respectively.

In the GPS signal loss with holdover active state 302, when GPS signal loss 350 occurs, instead of immediately transitioning to a free-run state as in the system 200 of FIG. 2, the CSR 312 enters a holdover mode. The oscillator 330 uses its last known good state to maintain accurate timing. The Te0/0/0/x (Master) port 332 and Te0/0/0/13 (Master) port 336 continue to distribute this maintained timing to the DU 314 and RU 316. The CSR 312 advertises a PTP class 7 clock through the Te0/0/0/13 (Master) port 336 and Te0/0/0/x (Master) port 332, indicating it is operating on a traceable backup source. Since clock class 7 is considered to be of acceptable PTP quality, the DU 314 continues in a locked state. At this point, the RU 316 also enters a holdover state upon receiving a SyncE=EEC-1 indication from the Te0/0/0/x (Master) port 332. In an example embodiment, this state can last up to 30 minutes, as indicated by timer 352, providing a stable backup timing source that maintains synchronization across the cell site for a sufficient period to outlast many typical GPS flapping events. This 30-minute holdover period addresses the challenge of bridging temporary GPS outages without impacting service quality. It allows normal operations to continue uninterrupted during brief primary reference losses, preventing the immediate service disruptions seen in FIG. 2. This holdover period may be configurable and may vary in different embodiments, for example based on when the oscillator 330 can no longer maintain accurate timing.

In the present example embodiment, only if the holdover period expires without GPS signal restoration 348 does the system 300 transition to the holdover expiration state 303. Here, it may be that the oscillator 330 can no longer maintain accurate timing. At this point, the CSR 312 changes its advertised clock class to 160, sent through the Te0/0/0/x (Master) port 332 and Te0/0/0/13 (Master) port 336, to indicate it is no longer providing traceable timing. The Te0/0/0/x (Master) port 332 and Te0/0/0/13 (Master) port 336 continue to distribute timing, which may be at a reduced quality. At this point, the RU 316 enters into a free-run state. In the free-run state, the RU 316 notifies the DU 314 regarding the change in clock class to 160 and stops radio radiation. Upon receiving the RU free-run notification, the DU 314 stops the UL/DL data transmission to the RU 316, as indicated by the absence of the UL/DL data line 358 and the resulting absence of data line 342 to the UE 344 in the holdover expiration state 303. The DU 314 also stops data transmission to the NTP Domain 356 as indicated by the absence of the data line 357 from the DU 314 to the NTP Domain 356 in the holdover expiration state 303. In an example embodiment, the CSR may be a Cisco® NCS 540 Series router. In such an embodiment, the Cisco® Network NCS 540 Series router has been upgraded to be running at least Cisco IOS XR Release 7.8.2.

This gradual transition, including the GPS signal loss with holdover active state 302, provides an improvement over the immediate disruption shown in FIG. 2, giving operators time to address the issue before service is impacted. By implementing the extended holdover technique described herein as illustrated by the system 300, cellular service providers can significantly reduce the impact of GPS flapping and other short-term timing disruptions, thereby minimizing dropped calls, service interruptions, and poor user experiences associated with the techniques shown in FIGS. 1A and 2.

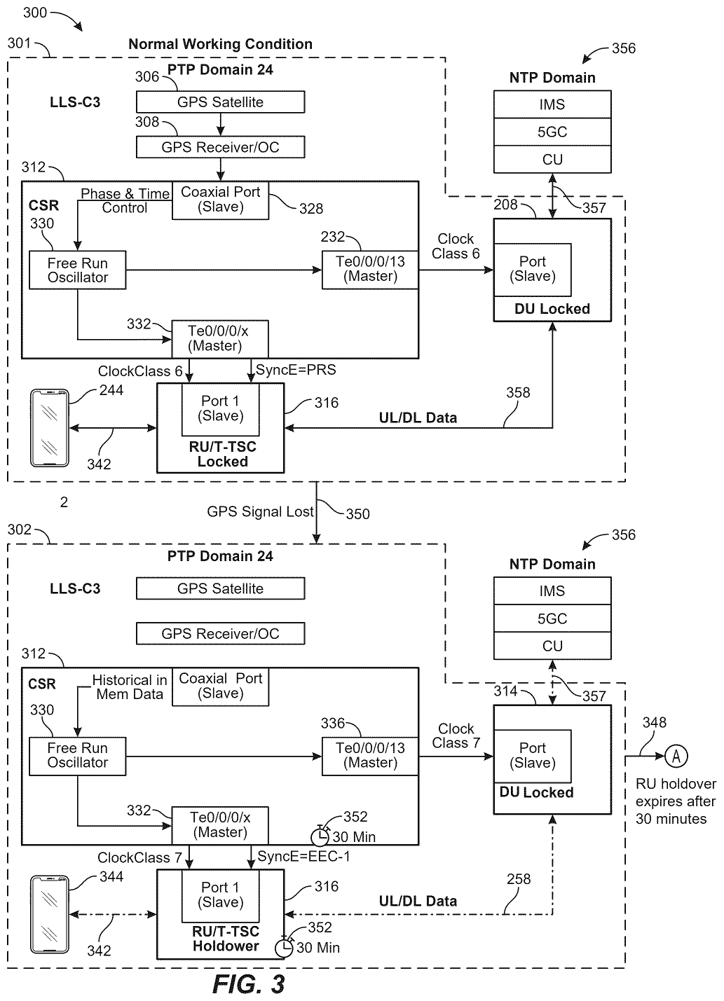

FIG. 4 is a flow diagram of an example method 400 for extended holdover timing in cellular networks that may be implemented within the system 300 of FIG. 3, according to one non-limiting embodiment.

At 402, a cloud services router (CSR) receives a primary timing reference signal from a GPS receiver.

At 404, the CSR detects a loss of the primary timing reference signal.

At 406, in response to detecting the loss of the primary timing reference signal, the system enters a holdover mode for a predetermined duration (e.g., 30 minutes) utilizing a first clock class indicating a traceable backup timing source. In an example embodiment, the first clock class is Precision Time Protocol (PTP) Class 7.

At 408, the system monitors for restoration of the primary timing reference signal.

At 410, in instances in which the primary timing reference signal is restored within the predetermined duration, the system transitions from the holdover mode to normal operation using the restored primary timing reference signal.

At 412, in instances in which the predetermined duration expires without restoration of the primary timing reference signal, the CSR advertises a second clock class indicating the CSR is in a free-run state. In an example embodiment, the second clock class is PTP Class 160. Prior to detecting the loss of the primary timing reference signal, in some embodiment, the CSR may discipline the internal oscillator of the CSR using the primary timing reference signal.

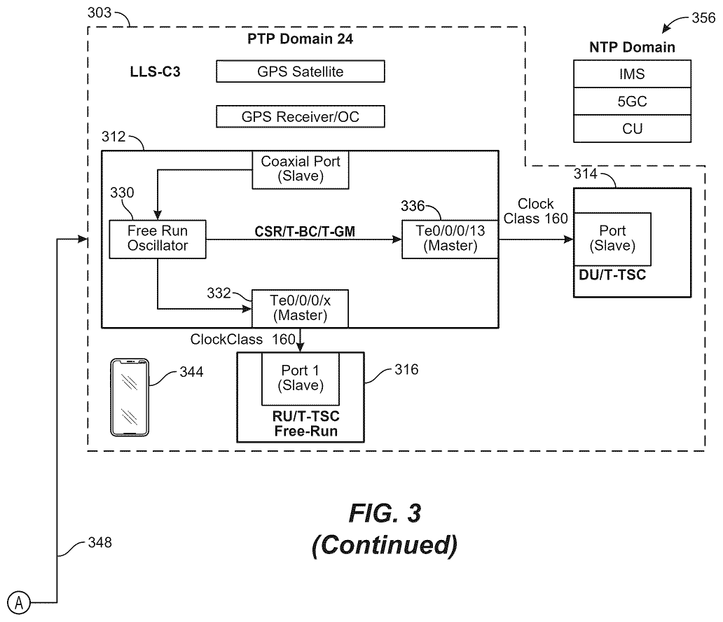

FIG. 5 is a flow diagram of an example method 500 for operating in holdover mode that is useful in the method 400 of FIG. 4, according to one non-limiting embodiment.

At 502, during the holdover mode, the CSR generates a backup timing signal using an internal oscillator of the CSR. In an example embodiment, generating the backup timing signal comprises applying phase and time alignment techniques based on historical data from the primary timing reference signal.

At 504, during the holdover mode, the CSR advertises the first clock class indicating a traceable backup timing source is in use.

At 506, during the holdover mode, the CSR provides the backup timing signal to one or more downstream network devices.

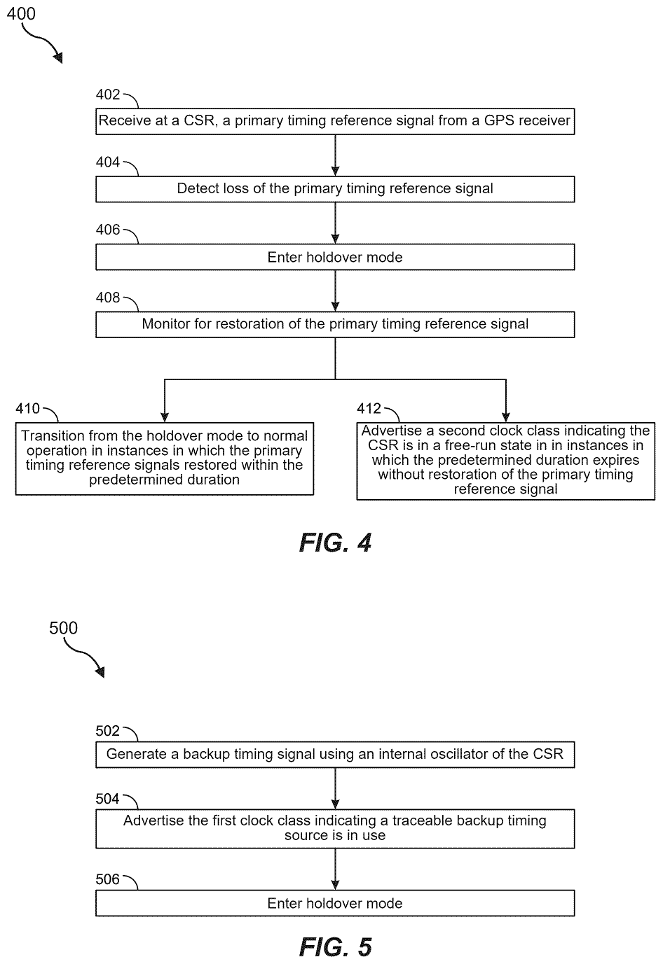

FIG. 6 is a flow diagram of an example method 600 for providing the backup timing signal to downstream network devices useful in the method 500 of FIG. 5, according to one non-limiting embodiment.

At 602, the CSR transmits Precision Time Protocol (PTP) signals derived from the backup timing signal.

At 604, the CSR transmits Synchronous Ethernet (SyncE) signals derived from the backup timing signal.

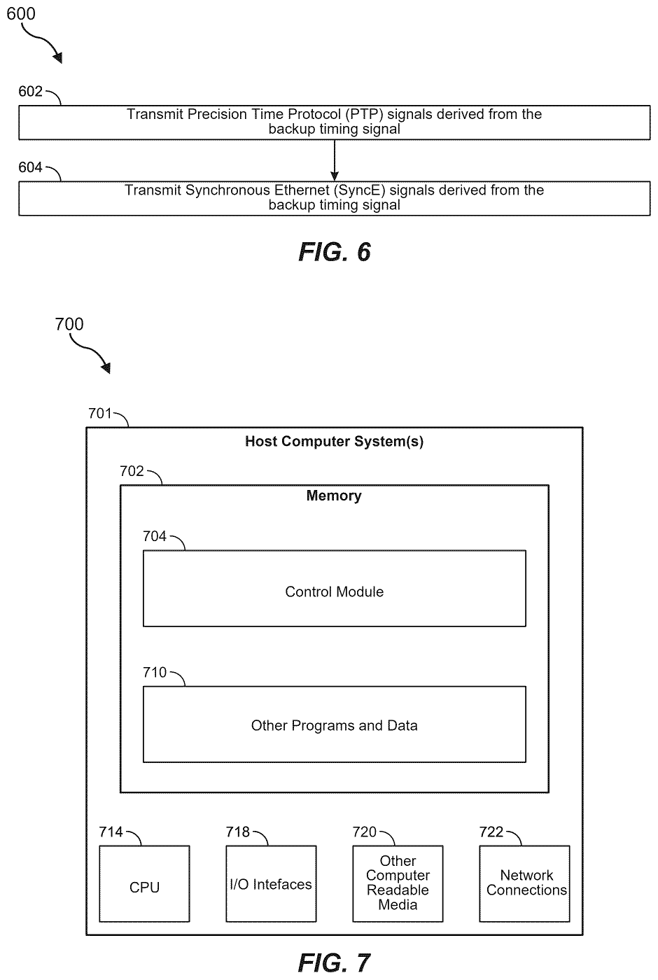

FIG. 7 shows a system diagram that describes an example implementation of a computing system(s) 700 for implementing embodiments described herein.

The functionality described herein for extended holdover timing in cellular networks can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent one or more of those in various data centers, servers, network nodes, base stations and cell sites shown and/or described herein that are, or that host or implement the functions of: routers, components, microservices, PODs, containers, nodes, node groups, control planes, clusters, virtual machines, network functions (NFs), and/or other aspects described herein for extended holdover timing in cellular networks. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more processors such as central processing units (CPUs) 714, I/O interfaces 718, other computer-readable media 720, and network connections 722.

Memory 702 may be coupled to CPUs 714 and include one or more various types of non-volatile and/or volatile storage technologies. Examples of memory 702 may include, but are not limited to, a computer-readable storage medium, flash memory, hard disk drives, optical drives, solid-state drives, various types of random access memory (RAM), various types of read-only memory (ROM), neural networks, other computer-readable storage media (also referred to as processor-readable storage media and non-transitory computer-readable storage media), or the like, or any combination thereof. Memory 702 may be utilized to store information, including computer-readable and computer-executable instructions that are utilized and executed by CPU 714 to cause operations to be performed, including those of embodiments described herein.

Memory 702 may have stored thereon control module(s) 704. The control module(s) 704 may be configured to implement and/or perform some or all of the functions of the systems, components and modules described herein for extended holdover timing in cellular networks. Memory 702 may also store other programs and data 710, which may include rules, databases, application programming interfaces (APIs), rules and data, software containers, nodes, PODs, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include location data interfaces, sensor data interfaces, interfaces, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for maintaining timing synchronization in a cellular network, the method comprising:
receiving, at a cloud services router (CSR), a primary timing reference signal from a GPS receiver;
detecting a loss of the primary timing reference signal;
in response to detecting the loss of the primary timing reference signal, entering a holdover mode for a predetermined duration utilizing a first clock class indicating a traceable backup timing source;
monitoring for restoration of the primary timing reference signal;
in instances in which the primary timing reference signal is restored within the predetermined duration, transitioning from the holdover mode to normal operation using the restored primary timing reference signal; and
in instances in which the predetermined duration expires without restoration of the primary timing reference signal, advertising a second clock class indicating the CSR is in a free-run state.

2. The method of claim 1 wherein the entering a holdover mode includes, during the holdover mode:
generating a backup timing signal using an internal oscillator of the CSR;
advertising the first clock class indicating a traceable backup timing source is in use; and
providing the backup timing signal to one or more downstream network devices.

3. The method of claim 2, wherein generating the backup timing signal comprises applying phase and time alignment techniques based on historical data from the primary timing reference signal.

4. The method of claim 2, wherein providing the backup timing signal to one or more downstream network devices comprises:
transmitting Precision Time Protocol (PTP) signals derived from the backup timing signal; and
transmitting Synchronous Ethernet (SyncE) signals derived from the backup timing signal.

5. The method of claim 1, wherein the first clock class is Precision Time Protocol (PTP) Class 7.

6. The method of claim 1, wherein the predetermined duration is 30 minutes.

7. The method of claim 1, wherein the second clock class is PTP Class 160.

8. The method of claim 1, further comprising:
prior to detecting the loss of the primary timing reference signal, disciplining an internal oscillator of the CSR using the primary timing reference signal.

9. A system for maintaining timing synchronization in a cellular network, the system comprising:
at least one processor; and
at least one memory coupled to the at least one processor, wherein the at least one memory has computer-executable instructions stored thereon that, when executed by the at least one processor, cause the at least one processor to cause operations to be performed, the operations including:
receiving, at a cloud services router (CSR), a primary timing reference signal from a GPS receiver;
detecting a loss of the primary timing reference signal;
in response to detecting the loss of the primary timing reference signal, entering a holdover mode for a predetermined duration utilizing a first clock class indicating a traceable backup timing source;
monitoring for restoration of the primary timing reference signal;
in instances in which the primary timing reference signal is restored within the predetermined duration, transitioning from the holdover mode to normal operation using the restored primary timing reference signal; and
in instances in which the predetermined duration expires without restoration of the primary timing reference signal, advertising a second clock class indicating the CSR is in a free-run state.

10. The system of claim 9 wherein the entering a holdover mode includes, during the holdover mode:
generating a backup timing signal using an internal oscillator of the CSR;
advertising the first clock class indicating a traceable backup timing source is in use; and
providing the backup timing signal to one or more downstream network devices.

11. The system of claim 10, wherein generating the backup timing signal comprises applying phase and time alignment techniques based on historical data from the primary timing reference signal.

12. The system of claim 10, wherein providing the backup timing signal to one or more downstream network devices comprises:
transmitting Precision Time Protocol (PTP) signals derived from the backup timing signal; and
transmitting Synchronous Ethernet (SyncE) signals derived from the backup timing signal.

13. The system of claim 9, wherein the first clock class is Precision Time Protocol (PTP) Class 7.

14. The system of claim 9, wherein the predetermined duration is 30 minutes.

15. A non-transitory computer-readable storage medium having computer-executable instructions stored thereon that, when executed by at least one processor, cause operations to be performed, the operations including:
receiving, at a cloud services router (CSR), a primary timing reference signal from a GPS receiver;
detecting a loss of the primary timing reference signal;
in response to detecting the loss of the primary timing reference signal, entering a holdover mode for a predetermined duration utilizing a first clock class indicating a traceable backup timing source;
monitoring for restoration of the primary timing reference signal;
in instances in which the primary timing reference signal is restored within the predetermined duration, transitioning from the holdover mode to normal operation using the restored primary timing reference signal; and
in instances in which the predetermined duration expires without restoration of the primary timing reference signal, advertising a second clock class indicating the CSR is in a free-run state.

16. The non-transitory computer-readable storage medium of claim 15 wherein the entering a holdover mode includes, during the holdover mode:
generating a backup timing signal using an internal oscillator of the CSR;
advertising the first clock class indicating a traceable backup timing source is in use; and
providing the backup timing signal to one or more downstream network devices.

17. The non-transitory computer-readable storage medium of claim 16, wherein generating the backup timing signal comprises applying phase and time alignment techniques based on historical data from the primary timing reference signal.

18. The non-transitory computer-readable storage medium of claim 16, wherein providing the backup timing signal to one or more downstream network devices comprises:
transmitting Precision Time Protocol (PTP) signals derived from the backup timing signal; and
transmitting Synchronous Ethernet (SyncE) signals derived from the backup timing signal.

19. The non-transitory computer-readable storage medium of claim 15, wherein the first clock class is Precision Time Protocol (PTP) Class 7.

20. The non-transitory computer-readable storage medium of claim 15, wherein the predetermined duration is 30 minutes.
